(19) United States
(12) Patent Application Publication
(10) Pub. No.: US 2020/0409543 A1
(43) Pub. Date: Dec. 31, 2020

(54) APPLICATION CUSTOM PROPERTY FRAMEWORK

(71) Applicant: Microsoft Technology Licensing, LLC, Redmond, WA (US)

(72) Inventors: Tsubomi Imamura, Los Altos, CA (US); Zi Wang, Mountain View, CA (US); Fermin Simeon, San Jose, CA (US); Albert Ho, Sunnyvale, CA (US); Viktar Starynski, Sunnyvale, CA (US); Peng Yuan, San Francisco, CA (US); Giathang Dao, Fremont, CA (US)

(21) Appl. No.: 16/456,097

(22) Filed: Jun. 28, 2019

(51) Int. Cl. G06F 3/0484; G06F 9/54; G06F 9/451

(52) U.S. Cl. CPC G06F 3/04847; G06F 9/451; G06F 9/54

(57) ABSTRACT

Methods, systems, and computer programs are presented for implementing configurable processing of data by an enterprise platform. One method includes an operation for receiving via an Application Programming Interface (API) of a frontend of an enterprise platform, a configuration file for configuring a custom property. Further, the method includes identifying services in a backend of the enterprise platform for implementing the custom property by the enterprise platform, the services comprising a storage service for storing values of the custom property. The method further includes operations for configuring program handlers for the custom property in the identified services, and for receiving a request, via the API of the frontend, to present a user interface (UI) for setting a value of the custom property. A presentation of the custom property is set in the UI based on the configuration of the custom property, and the UI is presented on a display.

### TECHNICAL FIELD

The subject matter disclosed herein generally relates to methods, systems, and machine-readable storage media for providing platform services to multiple clients.

### BACKGROUND

In some large systems, a platform service is used to store data from multiple internal clients that use the platform service for storage and presenting a user interface (UI). However, every time one of the internal clients needs to make a change, such as adding a new data item to be stored, the platform service needs to make changes throughout the different implementation layers in order to facilitate the access of the new data item, and other associated services with the data, such as presentation of the data on a user interface or performing validity checks for the data.

These types of changes tend to require programming and usually a large implementation cycle, even for some small changes. When there are many internal clients, the platform service becomes a bottleneck for the development of the products offered by the internal clients.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a user interface driven by an Application Custom Properties (ACP) configuration, according to some example embodiments.

FIG. 3 shows an architectural diagram of the enterprise platform, according to some example embodiments.

FIG. 4 illustrates an implementation of the enterprise platform that includes validation and sanitizers, according to some example embodiments.

FIG. 5 is a flowchart of a method for configuring the enterprise platform, according to some example embodiments.

FIG. 6 is a sample embodiment of a configuration.

FIG. 7 illustrates the flow of operations for rendering data, according to some example embodiments.

FIG. 8 is a diagram of a sample architecture for the enterprise platform, according to some example embodiments.

FIG. 9 is a flowchart of a method for implementing configurable processing of data by the enterprise platform, according to some example embodiments.

FIG. 10 is a block diagram illustrating an example of a machine upon or by which one or more example process embodiments described herein may be implemented or controlled.

### DETAILED DESCRIPTION

Example methods, systems, and computer programs are directed to implementing configurable processing of data by an enterprise platform. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

An online service may have multiple lines of business that offer different products or services, and the multiple lines of business share a common data infrastructure to manage shared data, e.g., user profile data. Each online service has its own requirements. For example, in a social network, one service may want to limit the number of social-network messages sent by recruiters; and other service may have a feature to turn on or off synchronizing with an external email provider, etc.

In prior solutions, each service has to implement its own backend (e.g., data store and processing) and its own frontend (e.g., user interface to support such exclusive properties). Each service has to implement solutions for data storage, data pipelines, Application Programming Interfaces (API), and customer user interfaces (Up that enables end users to access and modify such properties. A complete development process to add a new custom property and integrate the new customer property with the enterprise platform may take a long time, such as 4 months, to allow for the required programming, integration, and testing.

An Application Custom Properties (ACP) framework provides a simple way for all business units to define their own custom properties using configuration changes without any coding involved. The ACP framework also provides many additional features, such as searching, indexing, sorting, filtering by custom property, and enabling administrators to view and modify custom properties for individuals or large groups of users.

The ACP framework provides several advantages, including fast implementation, scalability, configurability, and improved performance and reliability. The ACP framework lowers the development time for creating new ACPs. In some estimates, with the ACP framework, development times may be up to 16 times faster than developments without the ACP framework services, but other solutions may include different acceleration parameters. To add a new property, a developer defines a new configuration that is stored on the backend. In some embodiments, the configuration is stored partially on the backend and partially on the frontend. The custom property may be presented on the user interface (UI).

Further, abstracting custom properties into configurations makes the platform easily scalable across many types of custom properties. This allows easily adding new custom properties across all business and easily adding new business lines.

Storing custom properties metadata in the configuration enables easy configuration of custom properties, while abstracting the implementation details from the developer. Further, using a single storage and management architecture for custom properties is more efficient that having each business store their own custom properties in their own storage systems, that is, it provides better performance and greater reliability.

Existing solutions enable custom forms to be generated through questions pertaining to a certain data type (e.g. radio buttons could be one-of-many, checkboxes could be many-of-many, short answer, or long answer). However, these solutions provide limited functionality, are much less flexible, require manual configuration, do not provide for integration within an enterprise platform, and are not well-suited for large-scale data systems.

One general aspect includes a method that includes an operation for receiving via the API of a frontend of an enterprise platform, a configuration file for configuring a custom property. Further, the method includes identifying services in a backend of the enterprise platform for implementing the custom property by the enterprise platform, the services comprising a storage service for storing values of the custom property. The method further includes operations for configuring program handlers for the custom property in the identified services, and for receiving a request, via the API of the frontend, to present a user interface (UI) for setting a value of the custom property. A presentation of the custom property is set in the UI based on the configuration of the custom property, and the UI is presented on a display.

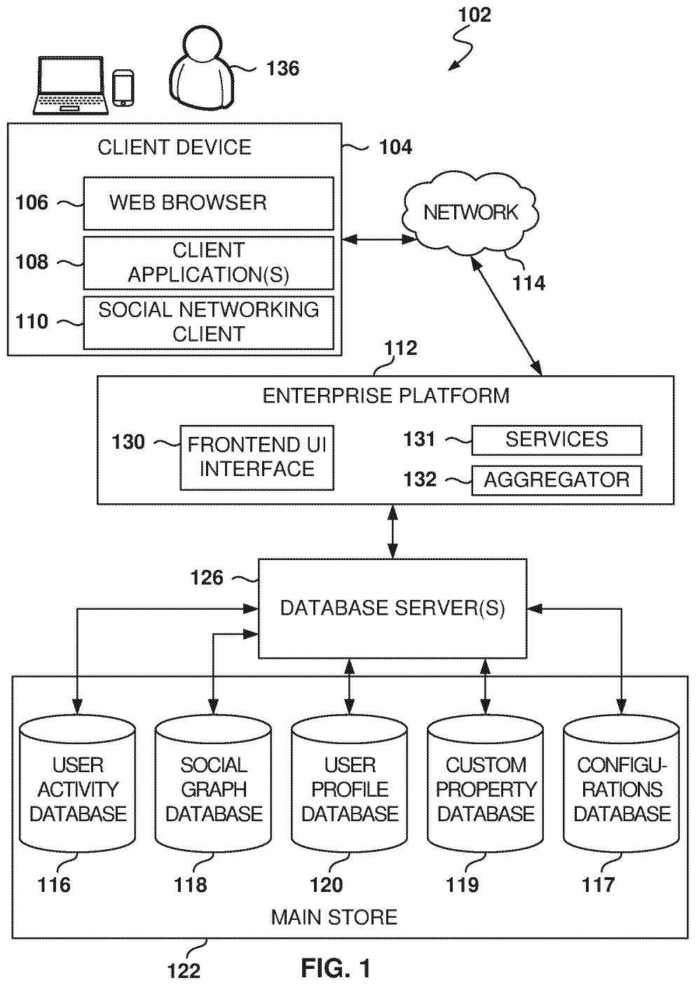

FIG. 1 is a block diagram illustrating a networked system, according to some example embodiments, including an enterprise platform 112, illustrating an example embodiment of a high-level client-server-based network architecture 102. Embodiments are presented with reference to an online service, but the principles used herein may be used for any online service accessed by users, such as a social networking service.

The enterprise platform 112 provides server-side functionality via a network 114 (e.g., the Internet or a wide area network (WAN)) to one or more client devices 104. FIG. 1 illustrates, for example, a web browser 106, client application(s) 108, and a social networking client 110 executing on a client device 104. The enterprise platform 112 is further communicatively coupled with one or more database servers 126 that provide access to main store 122 that includes one or more databases 116-120.

The client device 104 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a user 136 may utilize to access the enterprise platform 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, Global Positioning System (GPS) devices, and so forth.

In one embodiment, the enterprise platform 112 is a network-based appliance that responds to initialization requests or search queries from the client device 104. One or more users 136 may be a person, a machine, or other means of interacting with the client device 104. In various embodiments, the user 136 is not part of the network architecture 102 but may interact with the network architecture 102 via the client device 104 or another means.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the enterprise platform 112, on an as-needed basis, for data and/or processing capabilities not locally available (e.g., to access a user profile, to authenticate a user 136, to identify or locate other connected users 136, etc.). Conversely, if the social networking client 110 is not included in the client device 104, the client device 104 may use the web browser 106 to access the enterprise platform 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the enterprise platform 112 communicates with the one or more database servers 126 and databases 116-120. In one example embodiment, the enterprise platform 112 is communicatively coupled to a user activity database 116, a social graph database 118, a user profile database 120, a custom-property database 119, and a configurations database 117. The databases 116-120 may be implemented as one or more types of databases including, but not limited to, a hierarchical database, a relational database, an object-oriented database, one or more flat files, or combinations thereof.

The user profile database 120 stores user profile information about users 136 who have registered with the enterprise platform 112. With regard to the user profile database 120, the user 136 may include an individual person or an organization, such as a company, a corporation, a nonprofit organization, an educational institution, or other such organizations. The custom property database 119 includes data values for the customer properties, and the configurations database 117 includes configurations for custom properties.

In some example embodiments, when a user 136 initially registers to become a user 136 of the social networking service provided by the enterprise platform 112, the user 136 is prompted to provide some personal information, such as name, age (e.g., birth date), gender, interests, contact information, home town, address, spouse's and/or family users' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the user profile database 120. Similarly, when a representative of an organization initially registers the organization with the social networking service provided by the enterprise platform 112, the representative may be prompted to provide certain information about the organization, such as a company industry. This information may be stored, for example, in the user profile database 120.

As users 136 interact with the social networking service provided by the enterprise platform 112, the enterprise platform 112 is configured to monitor these interactions. Examples of interactions include, but are not limited to, commenting on posts entered by other users 136, viewing user profiles, editing or viewing a user 136's own profile, sharing content outside of the social networking service (e.g., an article provided by an entity other than the enterprise platform 112), updating a current status, posting content for other users 136 to view and comment on, posting job suggestions for the users 136, searching job postings, and other such interactions. In one embodiment, records of these interactions are stored in the user activity database 116, which associates interactions made by a user 136 with his or her user profile stored in the user profile database 120. A messaging database (not shown) stores messages exchanged among users.

While the database server(s) 126 are illustrated as a single block, one of ordinary skill in the art will recognize that the database server(s) 126 may include one or more such servers.

The enterprise platform 112 includes, among other modules, a frontend UI 130, one or more services 131, and an aggregator. More details regarding the functionality of these modules are provided below. Each of the modules may be implemented in software, hardware, or any combination of software and hardware.

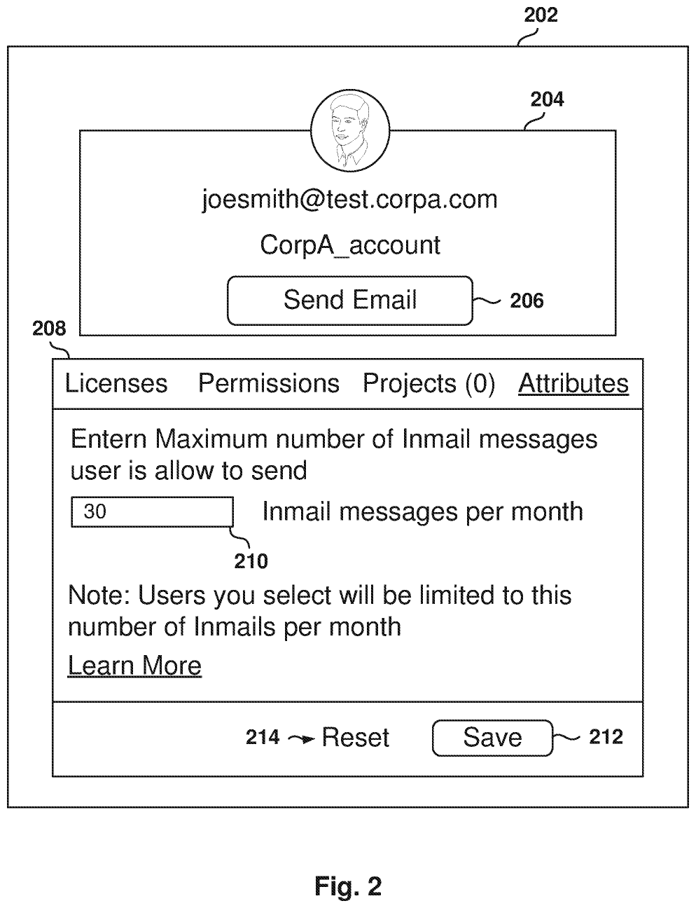

FIG. 2 is a user interface 202 driven by an ACP configuration, according to some example embodiments. The ACP framework provides, among other things, a mechanism for capturing custom data by different lines of business, also referred to herein as business units or businesses, which may be internal or external to the social network. The custom data is also referred to herein as a custom property or properties.

In general, the custom property is utilized by one business unit, although some custom properties may be shared by two or more business units. Other data kept by the ACP platform may be used by many, or all, business units, such as user profile information, including name, address, email, employment, etc. This type of data is referred to herein as shared data or shared properties.

The ACP platform stores the custom properties in one or more databases, and the ACP platform provides additional services beyond storage, such as utilities to validate the data, sanitize the data, manipulate the data, and present the data on a user interface. This way, a business unit that wants to add a new custom property may utilize the ACP platform to quickly add the custom property, simply by sending a configuration to the ACP platform. As a result, the business unit is able to quickly capture values for the custom property and access utilities to easily present the custom property in the way defined by the business unit.

The example user interface 202 is associated with a custom property of service for recruiters to access candidates in the online service. The custom property is for configuring a maximum number of Inmail messages per month sent by each user, the custom property being referred to as InmailMaxMonthly. An Inmail message is a message transmitted, by the online service, between a recruiter and a candidate that is a member of the online service.

The business unit would send a configuration to the ACP platform specifying that the InmailMaxMonthly is a positive integer greater than zero. It could also include optionally other parameters, such as a maximum number or a range of possible values (e.g., 10 to 200).

Further, the configuration includes information about how to present and validate InmailMaxMonthly. The configuration defines how to present information 204 for the user. An option to send Email 206 is provided in the UI. The window 208 includes information messages and an input box 210 for entering the maximum number of Inmails per month. Additionally, the user interface 202 includes options for resetting the page 214 and saving the data 212.

The configuration for InmailMaxMonthly optionally includes validation parameters for the input box 210, such as, the value must be an integer between 0 and 100. If the input entered by the user does not meet the conditions, the ACP platform will show an error message and request that the user reenters the number. The validation is performed by the ACP platform without having to communicate with the client from the business unit.

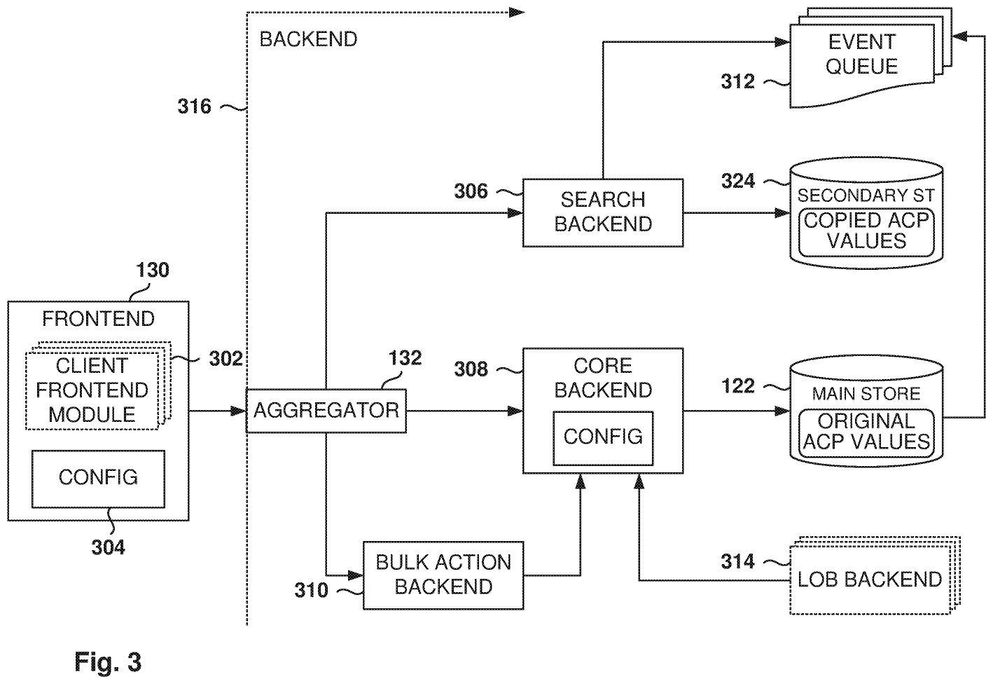

FIG. 3 shows an architectural diagram of the enterprise platform, according to some example embodiments. The enterprise platform includes a frontend 130 and a backend 316, which includes everything outside the frontend 130 in FIG. 3.

The frontend 130 handles the presentation layer, that is, the user interfaces provided to users of the online service, and 130 interfaces with the different business units, such as by providing an API. The frontend 130 renders the UI to the user based on the configuration, allows the business units to view and modify custom property values, performs searches for entities based on values of the custom properties (including sorting and filtering), and creates ACP bulk actions for bulk configuration editing.

The frontend 130 optionally includes client frontend modules 302 and the configurations 304 for the custom properties. The client frontend modules 302 are provided by the business units for interacting with the UI. The configuration 304 is a file that includes the definition of one or more custom properties and the metadata associated with each custom property, such as type (e.g., integer, real number, multiple-choice, extreme, etc.), formatting for the user interface, validation for input data, permissions, sanitization for the data (e.g., eliminate extra spaces, truncate a string to a certain maximum length, lowercase a text string), etc.

The configuration of custom properties includes, for example, modifying the presentation of the custom property or configuring batch processing of data associated with the custom property.

In some example embodiments, the backend 316 includes an aggregator 132, a search backend 306, a core backend 308, a bulk action backend 310, backend modules 314 of the business units (also referred to as line of business (LOB)), an event queue 312, the main store 122, and the secondary store 324. The secondary store 324 stores some of the information in the main store 122 for quicker response to incoming requests. The secondary store 324 provides faster access than the main store 122 and may also provide additional indexing for faster response times.

The main store 122 holds the values for the custom properties and the configurations and the secondary store 324 holds copies for some of the values of the custom properties, such as recently used custom properties for faster access.

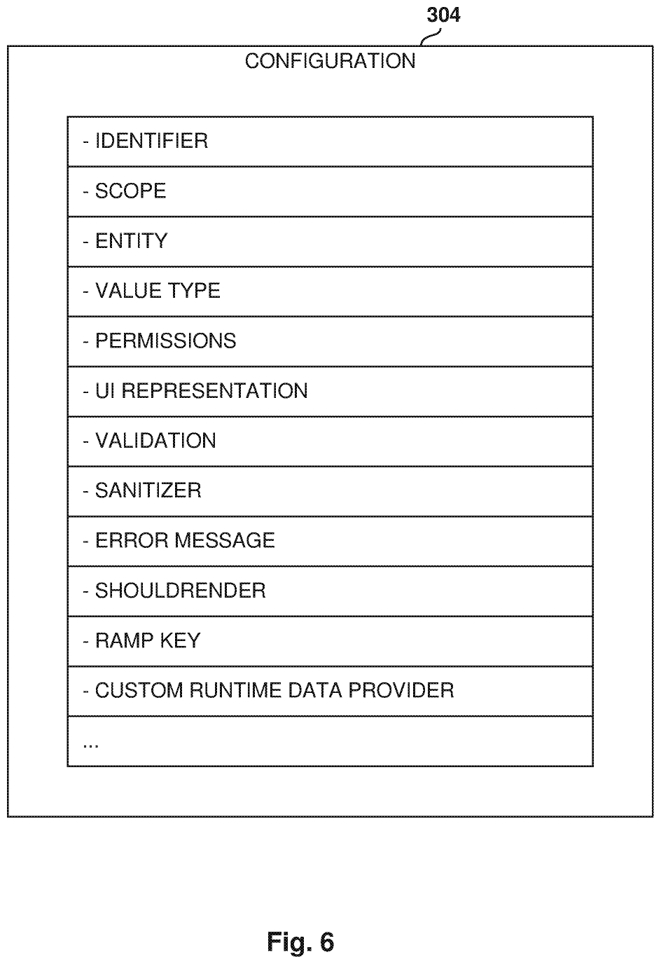

In some example embodiments, the configuration 304 contains the attributes such as identifier, scope, entity type, value type. More details about the configuration are provided below with reference to FIG. 6.

An ACP API is provided by the frontend 130 to perform configuration operations, such as setting or modifying configurations. An ACP Values Schema contains an identifier (unique ID of the configuration), entity URN (unique URN of an entity ACP), and an application instance.

The configuration values can be modified by the end user (via UI, CSV, or Bulk Action 310). In some example embodiments, the following API operations are provided to interact with custom property values: get by ID, update by ID, and find by entity.

ACP values are streamed using the event queue 312 to the secondary store (also referred to as search DB) to provide searching, sorting, and filtering capabilities. The bulk action feature allows the modification of configurations in bulk. Further, CSV support for the configurations allows the import and export of custom properties.

The aggregator 132 aggregates data received from different modules before returning the data to the frontend 130, such as when performing a search. The frontend 130 can send different types of requests to the aggregator 132, such as get or set custom properties, get or set configuration, search for entities, create a bulk action, or get the configuration in CSV format.

The aggregator 132 can send a command to the search backend 306 to search for entities with provided values for the custom properties. Further, the aggregator 132 can send a command to the bulk action backend 310 for an ACP bulk action (e.g., bundle of multiple ACP actions).

Further yet, the aggregator 132 communicates with the core backend 308 to perform requests, such as get or set configuration values, get the backend configuration, and get the configuration in CSV format.

The core backend 308 can send get or set ACP value requests to the main store 122 or to the LOB backend 314. The search backend 306 can send requests to the event queue 312 for processing, such as reading values of the custom properties or the configuration files. The search backend 306 can also send requests to the secondary store 324 for information about custom properties or configurations.

It is noted that the embodiments illustrated in FIG. 3 are examples and do not describe every possible embodiment. Other embodiments may utilize different modules, separate functionality into several modules, or combine functionality into a single module. The embodiments illustrated in FIG. 3 should therefore not be interpreted to be exclusive or limiting, but rather illustrative.

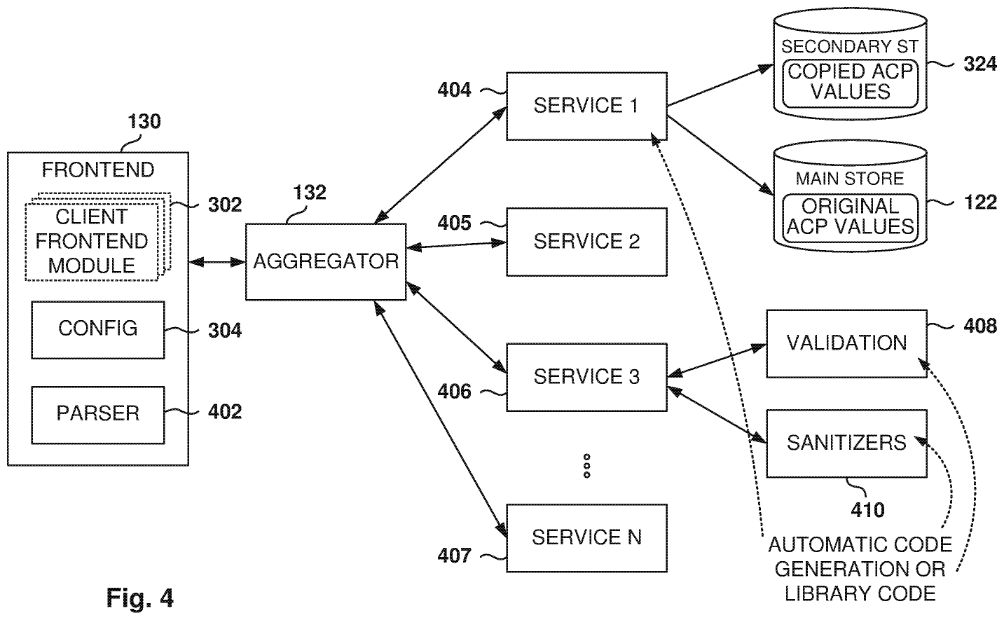

FIG. 4 illustrates an implementation of the enterprise platform that includes validation and sanitizers, according to some example embodiments. In general, a plurality of services 404-407 may be implemented in the backend 316. Each service may perform one or more functions, such as accessing the main store 122 or the secondary store 324. In this example, a service 3 406 is used to perform validation 408 of data (e.g., the value entered is within the allowed range, the value entered is an integer) and sanitization of data via one or more sanitizers 410.

For example, to add the InmailMaxMonthly value illustrated in FIG. 2, the configuration would set up the main store 122 to hold the values of InmailMaxMonthly for multiple users. To add this value, the configuration is sent to the frontend 130 via the frontend API.

In this case, the configuration for InmailMaxMonthly also includes validating that InmailMaxMonthly is a positive integer between one and 100. For other types of custom properties, the sanitizers 410 perform cleaning operations on the input, such as cleaning extra spaces in a text string.

When the custom property is added, the proper code for supporting the new custom property is added where needed, such as at service 1 404, validation 408, and sanitizers 410. The code may be automatically generated by a code generator based on the custom property configuration, or maybe added from a library of custom program handlers.

When a request comes in via the frontend 130, the request is transferred to the aggregator 132, which involves the necessary services to obtain the necessary data or set the necessary data. If data is returned, the aggregator 132 compiles information from the different services and transfers the results to the frontend 130 for responding to the requestor.

The configurations define how to interact with each service so the enterprise platform can handle the custom properties in the configuration. The business units do not have to write their own code for handling custom properties, and the business units can just add new custom properties simply by adding the correspondent configuration.

For example, a parser in the frontend 130 analyzes the configuration for the new custom property and the frontend 130 generates validation, sanitization, storage (possible with indexing), and access permissions, which determine who has access to add/delete/change the custom property or the configuration.

By using the configuration, the business units take advantage of additional services provided by the enterprise platform, such as indexing capabilities of the data, reporting, and batch processing. Instead of using a manual process to add new custom properties, the use of the configuration solves the problem by automatically generating the proper services and codes to handle the new custom properties. The business unit is able to add a new custom property without having to write custom programming code. The process of adding a new custom property may change, for example, from taking four months to one week.

Additionally, once the custom property is created, it is possible to change the configuration to add new features, such as to add indexing for the storage of the custom property values.

The secondary store 324 is kept in memory, in some example embodiments, and has more advanced indexing capabilities so the enterprise platform can perform advanced types of queries or input data from a file. Further, the secondary store 324 may support additional query types, that give additional flexibility to the users for searching data. However, the secondary store 324 is not durable, but the main store 122 is durable. Therefore, some queries may be satisfied from the main store 122, but other more complex queries will be performed using the secondary store 324.

The configuration also defines the presentation of data on the UI. The enterprise platform provides a set of utilities for presenting data on the UI, such as formatting of custom properties, placement of values, calculation of values based on two or more custom properties, data entry and validation, data sanitization, etc. This way, the business unit simply adds the configuration for the new custom property, together with the presentation parameters in the UI, and the new custom property appears on the UI without further changes required. The end user is now able to enter and read values for the new custom property.

For a set operation to update the value of a custom property, the set request comes via the API to the frontend 130. The frontend 130 sends the request to the aggregator 132, which invokes the appropriate services, such as service 1 404 to set the data in the main store 122. If the data needs to be indexed, the service 1 404 will index the data.

For a get operation, the request comes via the API to the frontend 130, which sends to the aggregator 132, which causes the service 1 404 to access the data from the main store 122 or from the secondary store 324.

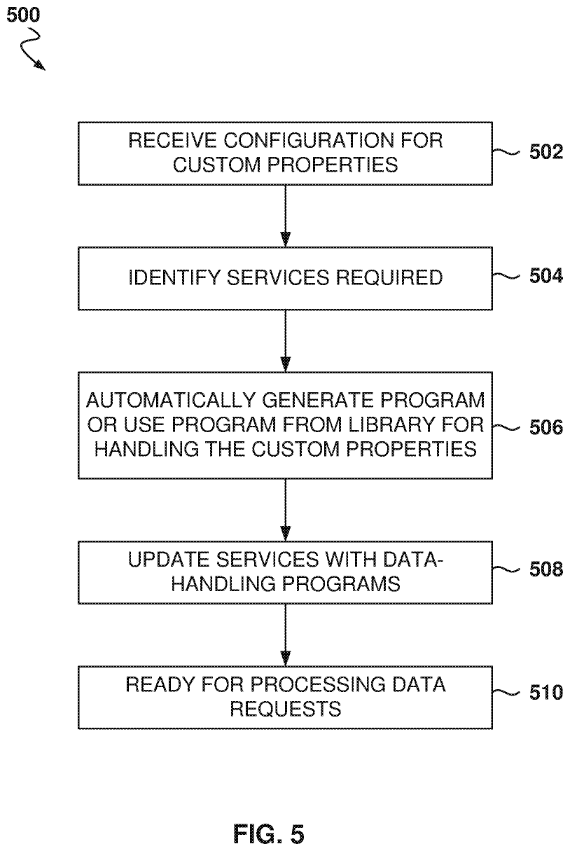

FIG. 5 is a flowchart of a method 500 for configuring the enterprise platform, according to some example embodiments. While the various operations in this flowchart are presented and described sequentially, one of ordinary skill will appreciate that some or all of the operations may be executed in a different order, be combined or omitted, or be executed in parallel.

As discussed earlier, the process for adding new custom properties is configuration driven r to automate the easy addition of new custom properties that are stored and supported by the enterprise platform.

At operation 502, the configuration is received for adding one or more custom properties. From operation 502, the method flows to operation 504 where the frontend identifies the services required (existing or new) to support the new custom properties.

For each identified service, a program handler is associated within the service for processing requests associated with the one or more custom properties. The program handler will execute when an operation associated with the corresponding custom property is performed. For example, the program handler may handle search queries, read and store operations, validations, sanitization, permissions, etc. For example, if an operation is not permitted for the user, the service will notify the aggregator that will return the corresponding error code for lack of permission to access.

From operation 504, the method flows to operation 506 where the enterprise platform automatically generates programs for handling the new custom properties or selects existing programs from a library.

At operation 508, the identified services are updated with the new data-handling programs to support the added custom properties. From operation 508, the method flows to operation 510, where the enterprise platform is ready for processing data requests associated with the added custom properties.

FIG. 6 is a sample embodiment of a configuration. In some example embodiments, the configuration includes the following entries:
Identifier, a unique ID of the configuration;
Scope, an identifier of the LOB that owns the configuration;
Entity type, a type of the entity that owns the configuration;
Value Type, type of the ACP value (e.g., Boolean, String, Long, Integer);
Permissions, that define who is allowed access to the configuration;
UI representation (e.g., label position, link text, radio-button orientation, drop down menu option list);
Validation, defines data-validation parameters;
Sanitizer, defines sanitization parameters;
Error message, to be presented when erroneous data is entered;
shouldRender flag, indicates if the custom property is shown or hidden.
Ramp Key, used for a new attribute ramp, feature isolation, and safety; and
Custom Runtime Data Provider (optional), reference to a Java class of custom data provider that has an ability to overwrite configuration settings at runtime.

It is noted that the embodiments illustrated in FIG. 6 are examples and do not describe every possible embodiment. Other embodiments may utilize different parameters, fewer parameters, or additional parameters. The embodiments illustrated in FIG. 6 should therefore not be interpreted to be exclusive or limiting, but rather illustrative.

The UI is configurable to dynamically show or hide a custom property in the UI. For custom properties defined in the configuration, there is a Boolean field shouldRender that indicates if the custom property is presented on the UI or not. The backend can also overwrite the default value via a dynamic configuration update. For example, an administrator can decide to turn off Inmail for certain users.

In order to achieve high reusability and dynamic UI behavior by the frontend 130, a library of generic program handlers is developed. The program handlers provide support for text inputs, radio buttons, drop-down lists, cell in a table, and so forth. These program handlers are driven by the configuration. For example, label position, label text, options for a dropdown list, default value and user configured value.

The static configuration is the initial configuration that is provided to define the custom properties and fixed parameters associated with the custom properties, such as a fixed position for presenting the value of the custom property. The dynamic configuration is used to pre-populate values of the custom properties or to make with indications to the dynamic configuration, such as changing a custom property from being an integer to be a real number.

For example, the dynamic configuration may be used to change the permissions initially provided in the static configuration to access a particular custom property. Also, the dynamic configuration may be used to change the way a custom property is shown, such as changing from a number field to multiple number ranges (e.g., for the age of a user).

The validation optionally sets up constraints on the values or the custom property, such as the custom property has to be a positive integer. However, the dynamic configuration may change the validation to be a positive real number. There is no need to change the validation code; a simple change to the configuration is what it takes to make the validation change. Similarly, an error message could be changed dynamically to have a different value, simply by changing the configuration.

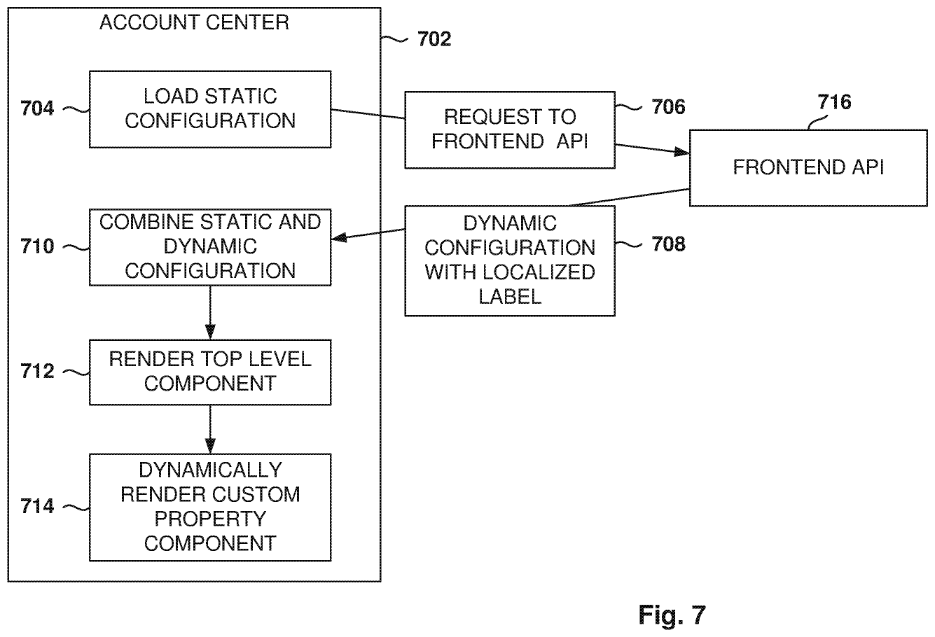

FIG. 7 illustrates the flow of operations for rendering data, according to some example embodiments. In some example embodiments, the frontend API 616 provides, at least, two operations for retrieving the configuration at runtime: a getComponentsMetadata(locationKeys) operation and a getAllColumnMetadata( ) operation.

The getComponentsMetadata(locationKeys) operation takes an array of unique component location keys and returns an array of objects that represents each component's configuration in same order of the input locationKeys.

The getAllColumnMetadata( ) operation returns an array of objects that represents cell component metadata to dynamically generate columns in a table.

Initially, the service loads the static configuration. When a user selects, on a browser, one of the products of the online service, the product sends an API request to get the dynamic part of the configuration for the specific product. The data is keyed by attribute ID, which matches the attribute ID in the static configuration. The service then performs a union between the two data sets and composes the current configuration for the product custom properties.

FIG. 7 illustrates the rendering flow. At operation 704, the account center 702 (e.g., client of the enterprise platform) loads static configuration and sends the request 706 for custom-property data to the frontend API 716. The frontend API 716 returns dynamic configuration with a localized label 708.

The account center 702 combines the static and the dynamic configuration at operation 710 and proceeds to render the top-level component at operation 712. At operation 714, the custom-property component is rendered dynamically. One example of rendering is presented above with reference to FIG. 2.

In one example for rendering the Inmail limit illustrated in FIG. 2, a custom property is defined for the InmailMaxMonthly as a text input type with a data type of integer. One example configuration is as follows:

```
“userDetail-form-inMail”: {
  “uiType”: “multiadmin/edit-attributes-modal”,
  “displayType”: “form”,
  “shouldRender”: true,
  “fields”: [{
  “attributeId”: “RECRUITER_INMAIL_LIMIT”,
  “dataType”: “integer”,
  “uiType”: “multiadmin/custom-property/ep-
text-field”,
  “displayType”: “primitive”,
  “shouldRender”: false,
  “label”: “inmail_limit_label”,
  “labelPosition”: “right”,
  “top”: {
    “label”: “inmail_limit_top_message”
  },
  “bottom”: {
    “label”: “inmail_limit_bottom_message”,
    “link”: “#?navigate=somewhere”,
    “linkLabel”: “inmail_learn_more”
  },
  “errorLabel”: “inmail_limit_error”
  }]
}
```

In this example, userDetail-form-inMail is the locationKey used to identify the custom property. The fields array defines how many components will be rendered inside multiadmin/edit-attributes-modal. In this simple case, there is one component multiadmin/custom-property/ep-text-field. Further, in this configuration, shouldRender is set to false, which means that this component will not be rendered by default.

When the client is active, the configuration service fetches the dynamic configuration via the frontend API. In this case, a dynamic configuration is sent to change shouldRender to true, in order to enable the rendering of the Inmail custom property, as follows:

```
{
  “type”: “int”,
  “attributeId”: “RECRUITER_INMAIL_LIMIT”,
  “shouldRender”: true,
}
```

The page which contains the userDetail-form-inMail locationKey renders multiadmin/edit-attributes-modal, which in turn renders multiadmin/custom-property/ep-text-field. The value of the custom property is fetched with a get request, and the result returned is a value of 30. After rendering, the result is illustrated in FIG. 2.

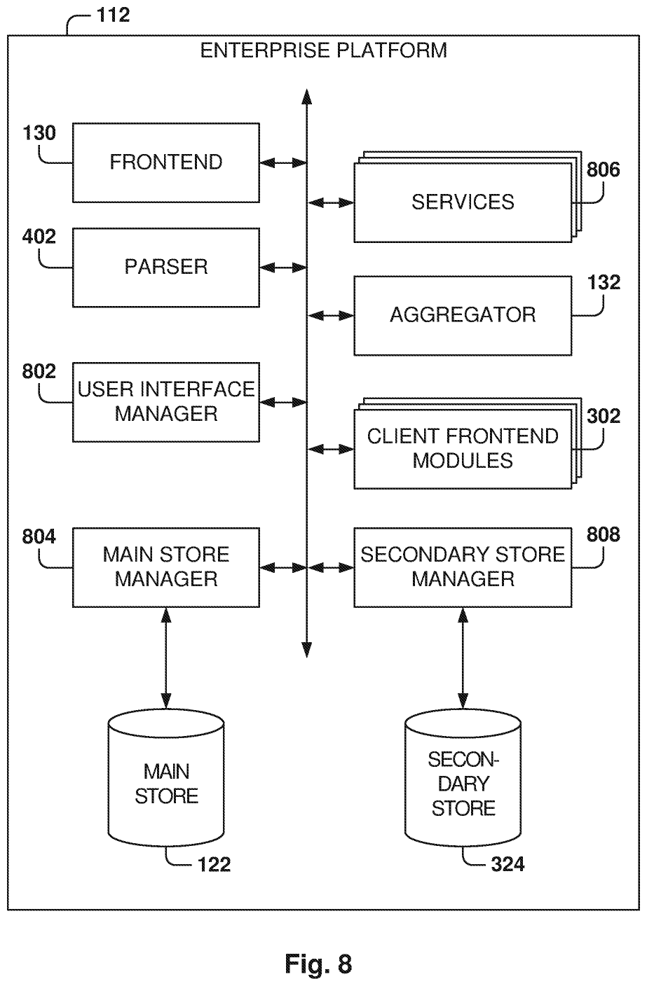

FIG. 8 is a diagram of a sample architecture for the enterprise platform, according to some example embodiments. In some example embodiments, the enterprise platform 112 includes the frontend 130, the parser 402, a user interface manager 802, a main store manager 804 that manages access to main store 122, one or more services 806, the aggregator 132, one or more client frontend modules 302, and a secondary store manager 808 that manages access to secondary store 324.

The user interface manager 802 manages interactions with the user interface, such as communications with the client device to present the user interface on a display.

The parser 402 parses configurations and determines the services required for each new custom property. The parser 402 then makes the changes to the backend to support the custom properties. The parser 402 validates the schema for the configuration and determines if library programs are available to support the functionality of a new custom property; otherwise, the parser 402 activate the generation of custom code (e.g., program handlers) to be added to the correspondent services for supporting the parameters of the custom properties.

It is noted that the embodiments illustrated in FIG. 8 are examples and do not describe every possible embodiment. Other embodiments may utilize different modules, additional modules, or combine modules into a single module. The embodiments illustrated in FIG. 8 should therefore not be interpreted to be exclusive or limiting, but rather illustrative.

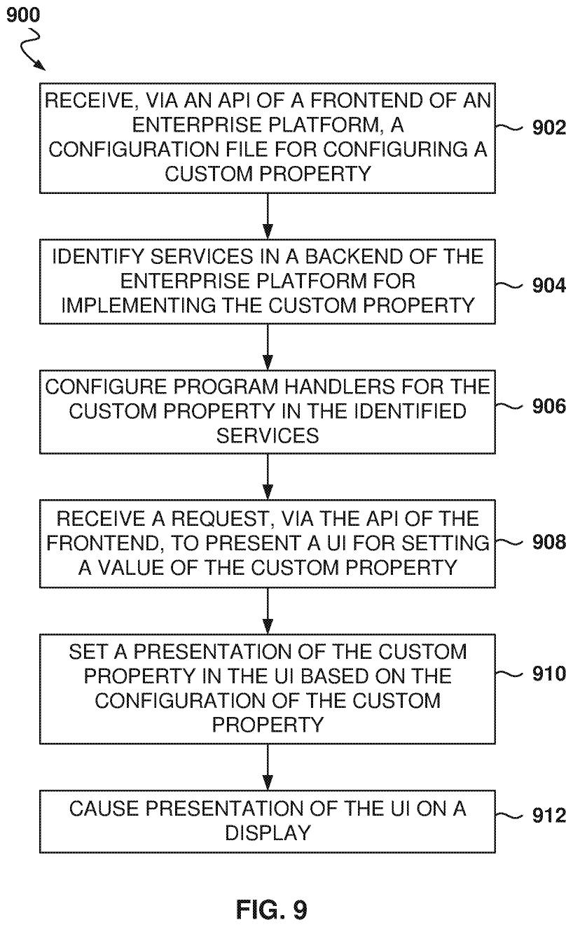

FIG. 9 is a flowchart of a method 900 for implementing configurable processing of data by the enterprise platform, according to some example embodiments. While the various operations in this flowchart are presented and described sequentially, one of ordinary skill will appreciate that some or all of the operations may be executed in a different order, be combined or omitted, or be executed in parallel.

At operation 902, one or more processors received, via an Application Programming Interface (API) of a frontend of an enterprise platform, a configuration file for configuring a custom property.

From operation 902, the method 900 flows to operation 904 for identifying, by the one or more processors, services in a backend of the enterprise platform for implementing the custom property by the enterprise platform. The services comprise a storage service for storing values of the custom property.

From operation 904, the method 900 flows to operation 906 where the one or more processors configure program handlers for the custom property in the identified services.

From operation 906, the method 900 flows to operation 908 where the one or more processors received a request, via the API of the frontend, to present a user interface (UI) for setting a value of the custom property.

From operation 908, the method 900 flows to operation 910 for setting, by the one or more processors, a presentation of the custom property in the UI based on the configuration of the custom property. At operation 912, the one or more processors cause presentation of the UI on a display.

In one example, the configuration file defines parameters for the custom property, the parameters being selected from a group comprising data type, presentation, validation, sanitization, permission, and indexing.

In one example, the configuration of the custom property comprises custom property identifier (ID), owner ID, value type, permissions, validation constraints, UI representation, error message, and flag indicating if custom property is renderable.

In one example, setting the presentation of the custom property in the UI comprises accessing formatting and validation parameters for the custom property, and setting the presentation of the custom property based on the formatting and validation parameters.

In one example, the method 900 further comprises returning, via the API of the frontend, a value entered by a user in the UI; and storing the value entered by the user in a permanent store.

In one example, the configuration of the custom property includes validation parameters for checking that user input for the custom property meets requirement of the validation parameters.

In one example, the configuration of the custom property includes sanitization parameters for sanitizing user input.

In one example, the enterprise platform comprises a backend that comprises an aggregator, a plurality of services, a main store a and a secondary store.

In one example, the method 900 further comprises: receiving, via the API of the frontend, a request to set a value of the custom property; sending the request from the frontend to the aggregator; and sending the request from the aggregator to the storage service.

In one example, properties of the custom property, identified in the configuration of the custom property, comprise being an integer value, a range of valid options, an error message when wrong input is entered, and presentation information for presenting the custom property in the UI.

Another general aspect is for a system that includes a memory comprising instructions and one or more computer processors. The instructions, when executed by the one or more computer processors, cause the one or more computer processors to perform operations comprising: receiving via the API of a frontend of an enterprise platform, a configuration file for configuring a custom property; identifying services in a backend of the enterprise platform for implementing the custom property by the enterprise platform, the services comprising a storage service for storing values of the custom property; configuring program handlers for the custom property in the identified services; receiving a request, via the API of the frontend, to present a UI for setting a value of the custom property; setting a presentation of the custom property in the UI based on the configuration of the custom property; and causing presentation of the UI on a display.

In yet another general aspect, a machine-readable storage medium (e.g., a non-transitory storage medium) includes instructions that, when executed by a machine, cause the machine to perform operations comprising: receiving via the API of a frontend of an enterprise platform, a configuration file for configuring a custom property; identifying services in a backend of the enterprise platform for implementing the custom property by the enterprise platform, the services comprising a storage service for storing values of the custom property; configuring program handlers for the custom property in the identified services; receiving a request, via the API of the frontend, to present a UI for setting a value of the custom property; setting a presentation of the custom property in the UI based on the configuration of the custom property; and causing presentation of the UI on a display.

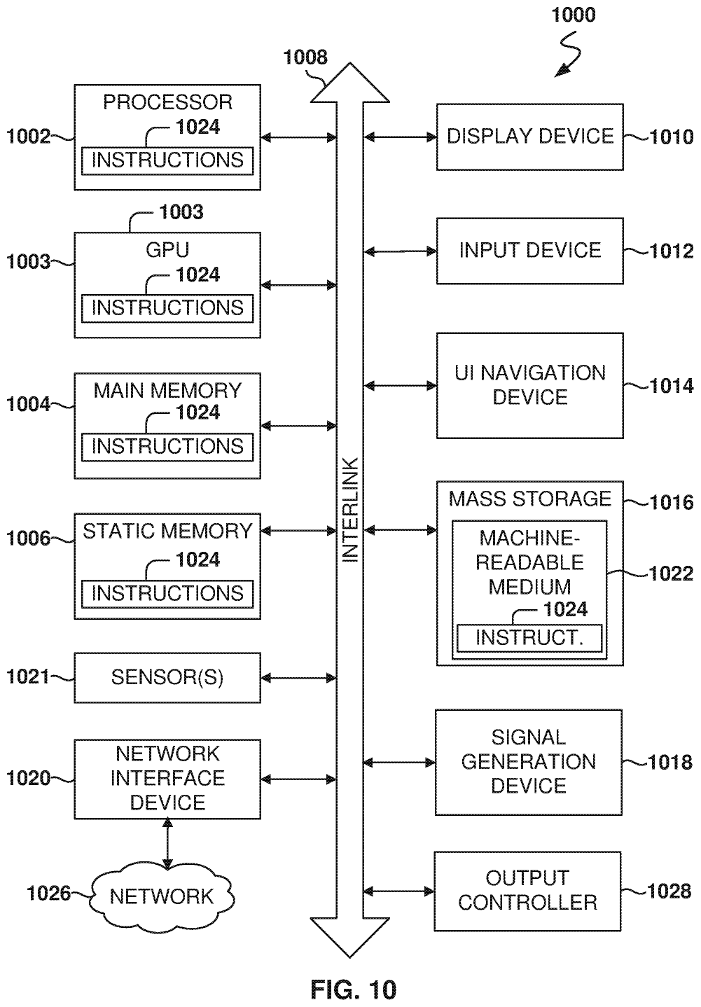

FIG. 10 is a block diagram illustrating an example of a machine 1000 upon or by which one or more example process embodiments described herein may be implemented or controlled. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in a peer-to-peer (P2P) (or other distributed) network environment. Further, while only a single machine 1000 is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, by moveable placement of invariant massed particles, etc.) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one user of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1000 may include a hardware processor 1002 (e.g., a central processing unit (CPU), a hardware processor core, or any combination thereof), a graphics processing unit (GPU) 1003, a main memory 1004, and a static memory 1006, some or all of which may communicate with each other via an interlink (e.g., bus) 1008. The machine 1000 may further include a display device 1010, an alphanumeric input device 1012 (e.g., a keyboard), and a user interface (UI) navigation device 1014 (e.g., a mouse). In an example, the display device 1010, alphanumeric input device 1012, and UI navigation device 1014 may be a touch screen display. The machine 1000 may additionally include a mass storage device (e.g., drive unit) 1016, a signal generation device 1018 (e.g., a speaker), a network interface device 1020, and one or more sensors 1021, such as a Global Positioning System (GPS) sensor, compass, accelerometer, or another sensor. The machine 1000 may include an output controller 1028, such as a serial (e.g., universal serial bus (USB)), parallel, or other wired or wireless (e.g., infrared (IR), near field communication (NFC), etc.) connection to communicate with or control one or more peripheral devices (e.g., a printer, card reader, etc.).

The mass storage device 1016 may include a machine-readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, within the hardware processor 1002, or within the GPU 1003 during execution thereof by the machine 1000. In an example, one or any combination of the hardware processor 1002, the GPU 1003, the main memory 1004, the static memory 1006, or the mass storage device 1016 may constitute machine-readable media.

While the machine-readable medium 1022 is illustrated as a single medium, the term “machine-readable medium” may include a single medium, or multiple media, (e.g., a centralized or distributed database, and/or associated caches and servers) configured to store the one or more instructions 1024.

The term “machine-readable medium” may include any medium that is capable of storing, encoding, or carrying instructions 1024 for execution by the machine 1000 and that cause the machine 1000 to perform any one or more of the techniques of the present disclosure, or that is capable of storing, encoding, or carrying data structures used by or associated with such instructions 1024. Non-limiting machine-readable medium examples may include solid-state memories, and optical and magnetic media. In an example, a massed machine-readable medium comprises a machine-readable medium 1022 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory EPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device 1020.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, by one or more processors, via an Application Programming Interface (API) of a frontend of an enterprise platform, a configuration file for configuring a custom property;
identifying, by the one or more processors, services in a backend of the enterprise platform for implementing the custom property by the enterprise platform, the services comprising a storage service for storing values of the custom property;
configuring, by the one or more processors, program handlers for the custom property in the identified services;
receiving, by the one or more processors, a request, via the API of the frontend, to present a user interface (UI) for setting a value of the custom property;
setting, by the one or more processors, a presentation of the custom property in the UI based on the configuration of the custom property; and
causing, by the one or more processors, presentation of the UI on a display.

2. The method as recited in claim 1, wherein the configuration file defines parameters for the custom property, the parameters being selected from a group comprising data type, presentation, validation, sanitization, permission, and indexing.

3. The method as recited in claim 1, wherein the configuration of the custom property comprises custom property identifier (ID), owner ID, value type, permissions, validation constraints, UI representation, error message, and flag indicating if custom property is renderable.

4. The method as recited in claim 1, wherein setting the presentation of the custom property in the UI comprises:
accessing formatting and validation parameters for the custom property; and
setting the presentation of the custom property based on the formatting and validation parameters.

5. The method as recited in claim 1, further comprising:
returning, via the API of the frontend, a value entered by a user in the UI; and
storing the value entered by the user in a permanent store.

6. The method as recited in claim 1, wherein the configuration of the custom property includes validation parameters for checking that user input for the custom property meets requirement of the validation parameters.

7. The method as recited in claim 1, wherein the configuration of the custom property includes sanitization parameters for sanitizing user input.

8. The method as recited in claim 1, wherein the enterprise platform comprises a backend that comprises an aggregator, a plurality of services, a main store a and a secondary store.

9. The method as recited in claim 8, further comprising:
receiving, via the API of the frontend, a request to set a value of the custom property;
sending the request from the frontend to the aggregator; and
sending the request from the aggregator to the storage service.

10. The method as recited in claim 1, wherein properties of the custom property, identified in the configuration of the custom property, comprise being an integer value, a range of valid options, an error message when wrong input is entered, and presentation information for presenting the custom property in the UI.

11. A system comprising:
a memory comprising instructions; and
one or more processors, wherein the instructions, when executed by the one or more processors, cause the system to perform operations comprising:
receiving via an Application Programming Interface (API) of a frontend of an enterprise platform, a configuration file for configuring a custom property;
identifying, by the one or more processors, services in a backend of the enterprise platform for implementing the custom property by the enterprise platform, the services comprising a storage service for storing values of the custom property;
configuring, by the one or more processors, program handlers for the custom property in the identified services;
receiving, by the one or more processors, a request, via the API of the frontend, to present a user interface (UI) for setting a value of the custom property;
setting, by the one or more processors, a presentation of the custom property in the UT based on the configuration of the custom property; and
causing, by the one or more processors, presentation of the UI on a display.

12. The system as recited in claim 11, wherein the configuration file defines parameters for the custom property, the parameters being selected from a group comprising data type, presentation, validation, sanitization, permission, and indexing.

13. The system as recited in claim 11, wherein setting the presentation of the custom property in the UI comprises:
accessing formatting and validation parameters for the custom property; and
setting the presentation of the custom property based on the formatting and validation parameters.

14. The system as recited in claim 11, wherein the instructions further cause the one or more computer processors to perform operations comprising:
returning, via the API of the frontend, a value entered by a user in the UI; and
storing the value entered by the user in a permanent store.

15. The system as recited in claim 11, wherein the configuration of the custom property includes validation parameters for checking that user input for the custom property meets requirement of the validation parameters.

16. A non-transitory machine-readable storage medium including instructions that, when executed by a machine, cause the machine to perform operations comprising:
receiving via an Application Programming Interface (API) of a frontend of an enterprise platform, a configuration file for configuring a custom property;
identifying services in a backend of the enterprise platform for implementing the custom property by the enterprise platform, the services comprising a storage service for storing values of the custom property;
configuring program handlers for the custom property in the identified services;
receiving a request, via the API of the frontend, to present a user interface (UI) for setting a value of the custom property;
setting a presentation of the custom property in the UI based on the configuration of the custom property; and
causing presentation of the UI on a display.

17. The non-transitory machine-readable storage medium as recited in claim 16, wherein the configuration file defines parameters for the custom property, the parameters being selected from a group comprising data type, presentation, validation, sanitization, permission, and indexing.

18. The non-transitory machine-readable storage medium as recited in claim 16, wherein setting the presentation of the custom property in the UI comprises:
accessing formatting and validation parameters for the custom property; and
setting the presentation of the custom property based on the formatting and validation parameters.

19. The non-transitory machine-readable storage medium as recited in claim 16, wherein the machine further performs operations comprising:
returning, via the API of the frontend, a value entered by a user in the UI; and
storing the value entered by the user in a permanent store.

20. The non-transitory machine-readable storage medium as recited in claim 16, wherein the configuration of the custom property includes validation parameters for checking that user input for the custom property meets requirement of the validation parameters.
